(19) United States
(12) Patent Application Publication
(10) Pub. No.: US 2014/0358514 A1
(43) Pub. Date: Dec. 4, 2014

(54) SYSTEM AND METHOD FOR AUTOMATICALLY GENERATING OFFLINE RESULT EMULATION FILES FROM A TESTFLOW

(71) Applicant: Nvidia Corporation, Santa Clara, CA (US)

(72) Inventor: Sheng-Liang Liu, HsinChu (TW)

(21) Appl. No.: 13/906,473

(22) Filed: May 31, 2013

(51) Int. Cl. G06F 9/455

(52) U.S. Cl. CPC G06F 9/455
USPC 703/22

(57) ABSTRACT

A system for, and method of automatically generating a structured data file for offline result emulation (ORE). In one embodiment, the system includes: (1) a testflow integrator configured to populate a supported testsuite with parameters from a testflow corresponding to a test program and (2) a device under test description integrator associated with the testflow integrator and configured further to populate the supported testsuite with parameters from at least one device under test description file.

### TECHNICAL FIELD

This application is directed, in general, to circuit testing and, more specifically, to a system and method for debugging or regressing-testing test programs or fabricated circuits, such as ICs.

### BACKGROUND

As those skilled in the pertinent art are aware, it is highly advantageous to test fabricated integrated circuits (ICs) to verify that they operate according to design. For this reason, various tools have been developed to test ICs (such as systems-on-a-chip, or SoCs). Advantest Corporation of Tokyo, Japan, sells one such tool, called the SmarTest V93000 SOC. Such tools employ a test program of functional test patterns that provide known signals to, and analyze signals received from, the IC under test (also called a “device under test,” or DUT). To create the test program, engineers first devise test procedures (“testflow”) tailored for the IC to be tested and then write the test program from the testflow. The test program is then verified using a fabricated IC. Samples of ICs may then be tested “online” as they are fabricated.

Revision 7.0 of Smartest introduced a feature, called “Offline Result Emulation,” or ORE, that allows an IC or the test program itself to be verified (e.g., debugged and regression tested) “offline,” or without the IC being employed in the process. According to Advantest, ORE provides a description of expected results and errors in functional test patterns. Advantest estimates that ORE can reduce engineering time spent verifying test programs only after IC fabrication by over two weeks, which is significant.

### SUMMARY

One aspect provides a system for automatically generating a structured data file for ORE. In one embodiment, the system includes: (1) a testflow integrator configured to populate a supported testsuite with parameters from a testflow corresponding to a test program and (2) a DUT description integrator associated with the testflow integrator and configured further to populate the supported testsuite with parameters from at least one DUT description file.

Another aspect provides a method of automatically generating a structured data file for ORE. In one embodiment, the method includes: (1) allowing a testflow corresponding to a test program to be selected, (2) providing a plurality of selectable supported testsuites, (3) populating a selected one of the supported testsuites with parameters from the testflow, (4) further populating the selected one of the supported testsuites with parameters from at least one DUT description file thereby to yield a structured data file and (5) employing the structured data file in the ORE.

Yet another aspect provides an offline result emulator. In one embodiment, the ORE emulator includes: (1) a testflow integrator configured to populate a supported testsuite with parameters from a testflow corresponding to a test program and (2) a DUT description integrator associated with the testflow integrator and configured further to populate the supported testsuite with parameters from a complete device directory describing a DUT corresponding to the testflow and the test program.

### BRIEF DESCRIPTION

Reference is now made to the following descriptions taken in conjunction with the accompanying drawings, in which:

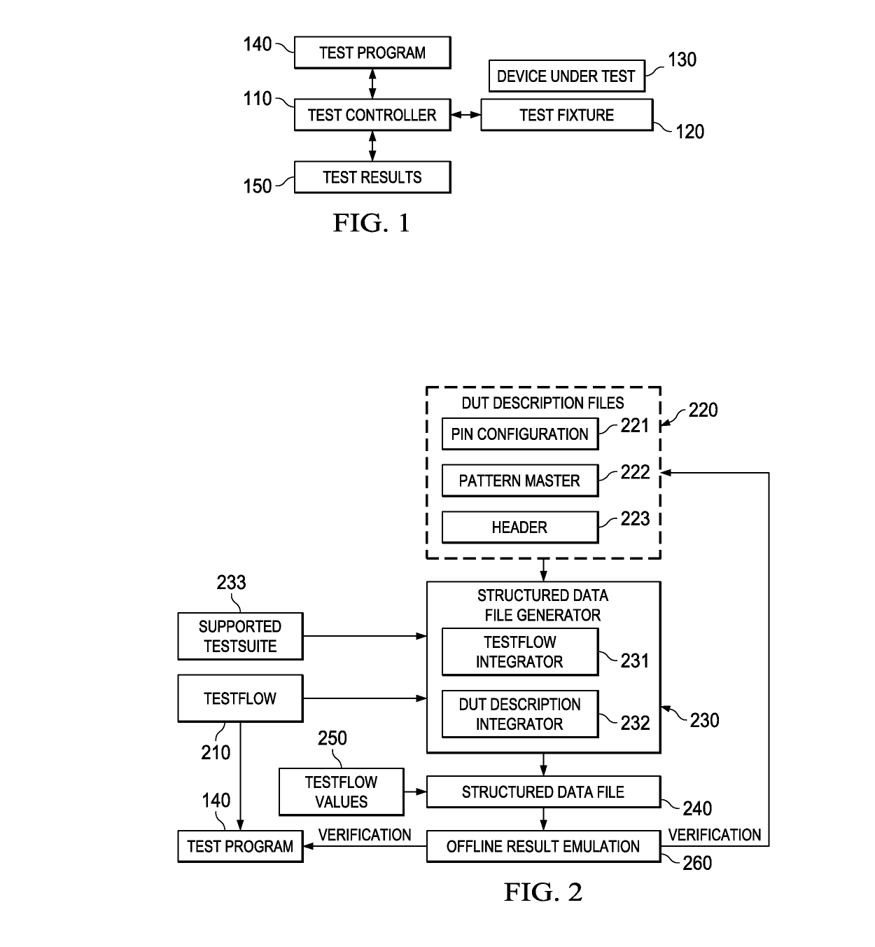

FIG. 1 is a block diagram of one embodiment of an IC test tool;

FIG. 2 is a block diagram of one embodiment of a system for automatically generating an ORE XML file;

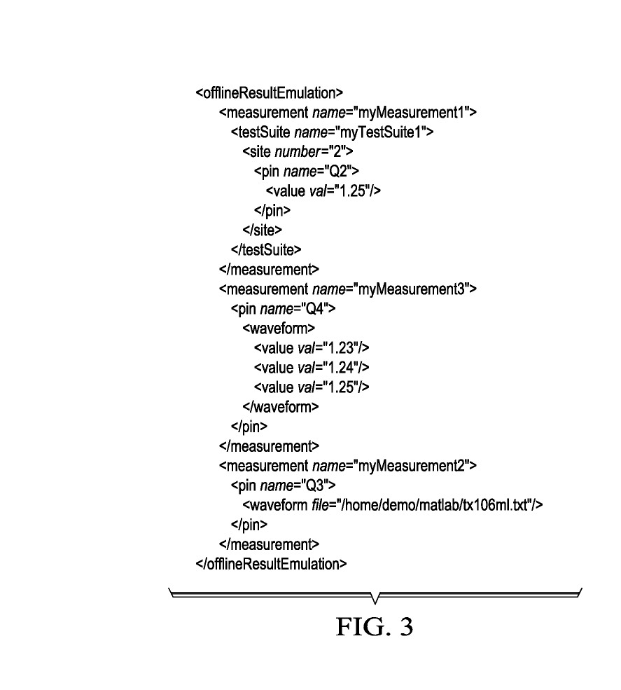

FIG. 3 is a portion of an example ORE setup file rendered in XML;

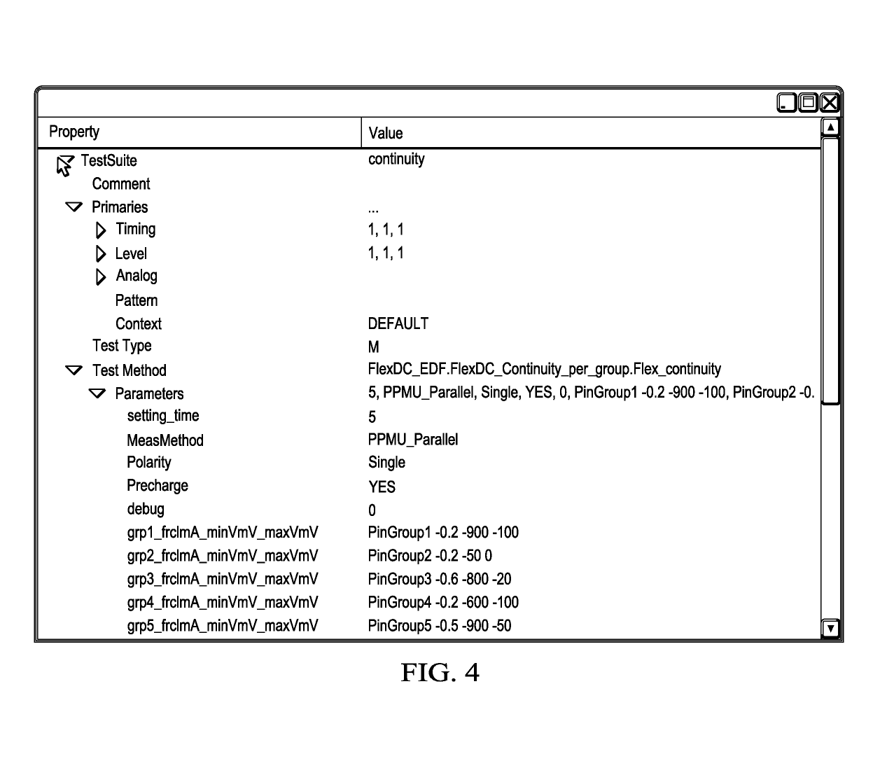

FIG. 4 is a portion of an example supported testsuite employable to create an ORE setup file;

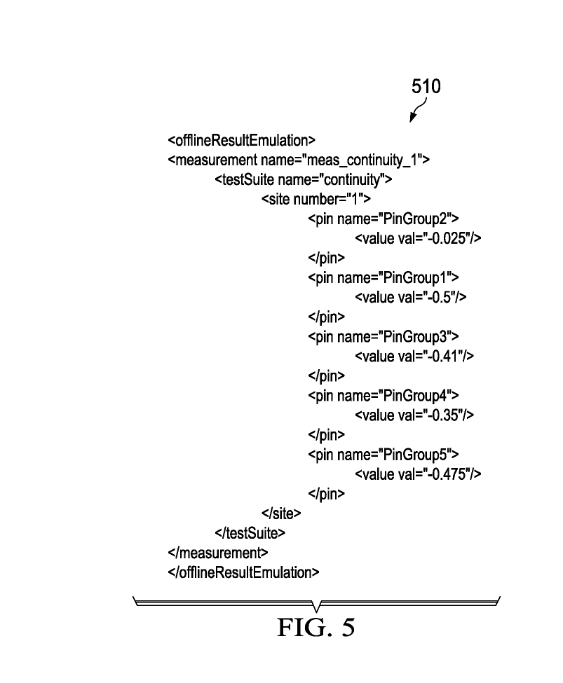

FIG. 5 is a portion of an example of an XML ORE setup file created from the supported testsuite of FIG. 3;

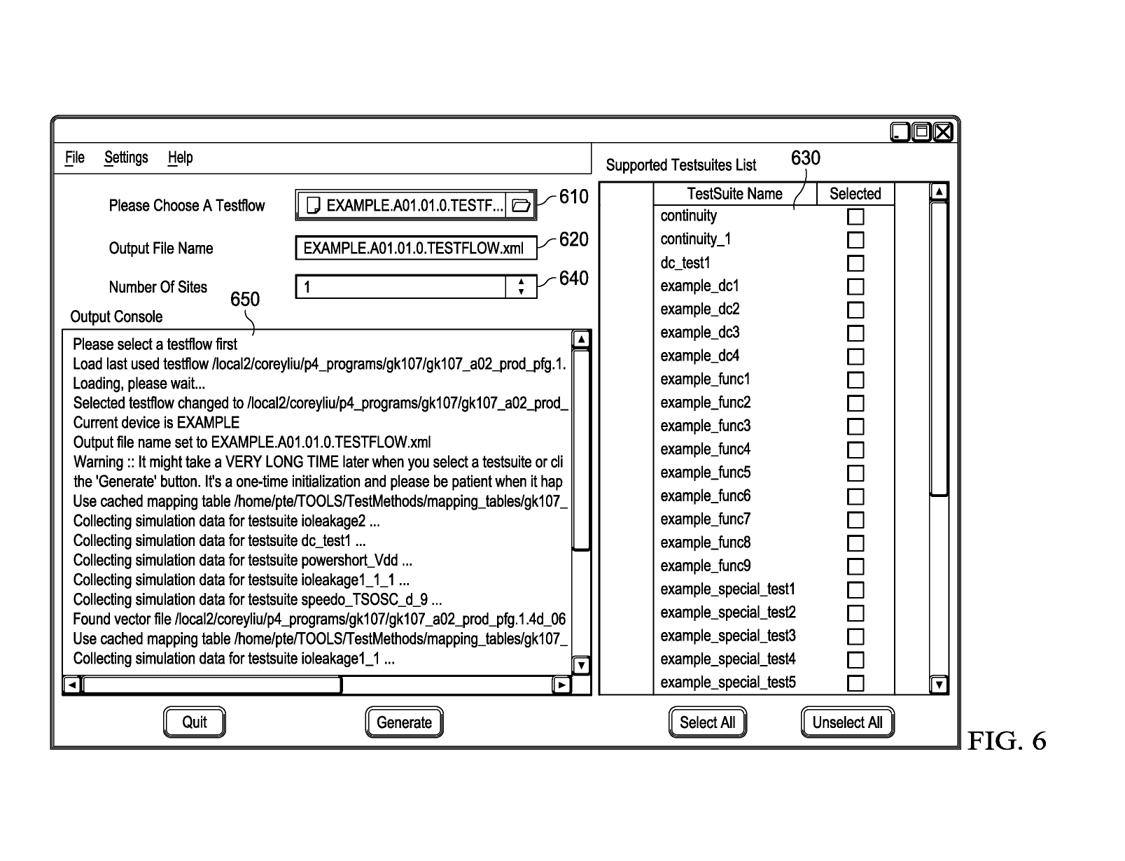

FIG. 6 is a screenshot produced by one embodiment of a system for automatically generating an ORE XML file;

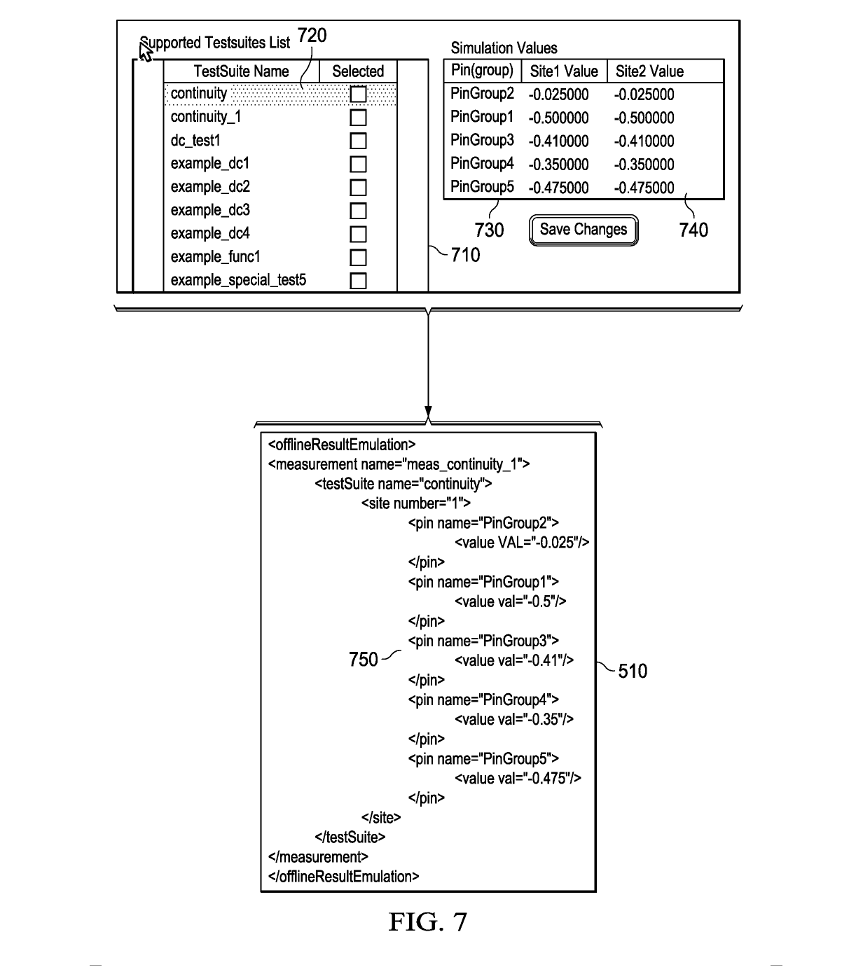

FIG. 7 is a diagram illustrating the generation of an ORE setup file from a supported testsuite and a simulation values file;

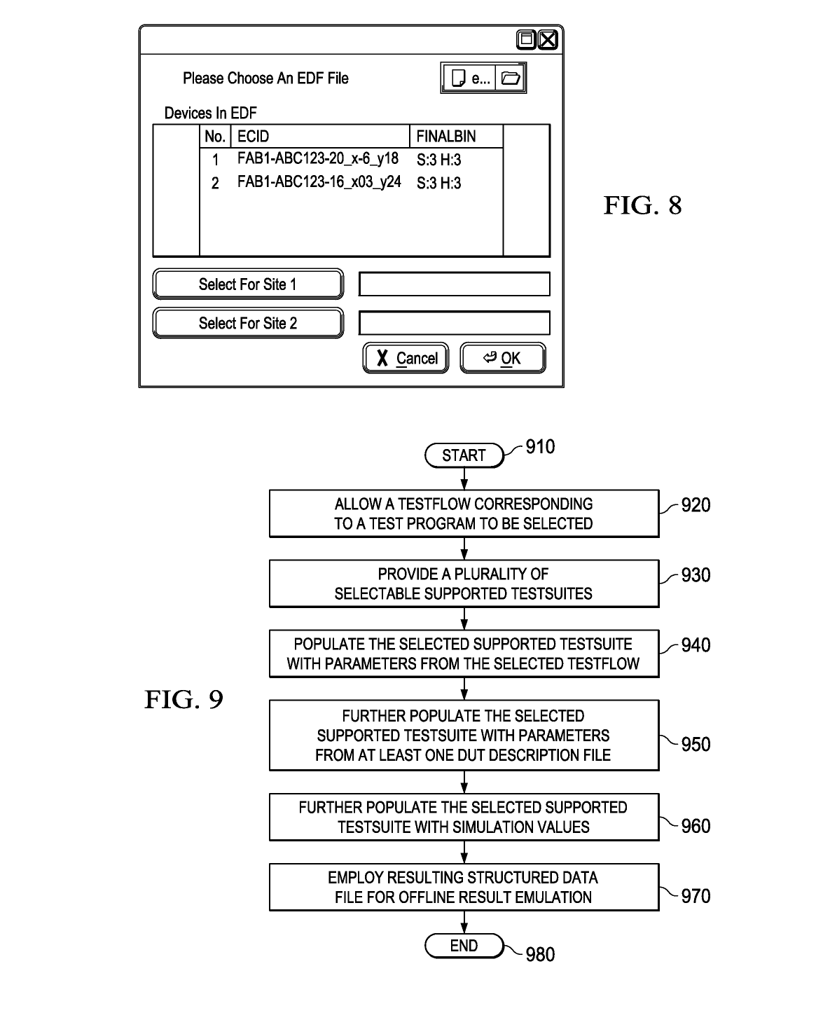

FIG. 8 is a diagram of one embodiment of a screenshot illustrating the import of testsuite values; and

FIG. 9 is a flow diagram of one embodiment of a method of automatically generating an ORE XML file.

### DETAILED DESCRIPTION

ORE allows a test program to be verified before ICs to be tested by the test program are fabricated. Alternatively, ORE allows a test program to verify an IC that is not physically available for online testing. ORE is claimed significantly to reduce engineering time that would otherwise be spent verifying test programs only after an IC is fabricated or shipping fabricated ICs to test tools for online testing. In an ideal situation, a test program would be verified just before it is needed to test newly-fabricated ICs or should problems occur during manufacturing. Such “offline” testing could be performed remotely, perhaps far from the manufacturing line itself.

ORE seems to offer a promising new capability. However, it requires a structured data file, representing the testflow and the IC that is to be tested, be created beforehand. In the case of SmarTest V93000, the structured data file takes the form of an eXtensible Markup Language (XML) data file, which has a structure and syntax known to those of skill in the pertinent art.

It should be apparent to those skilled in the pertinent art that for ORE to be efficacious, the XML data file should be both accurate and complete. It is realized herein that since such a data file incorporates data derived from several different sources, including the testflow and various files descriptive of the IC (e.g., pin configuration, pattern master and header files), generating the data file by hand can be a daunting task, even when the testflow involves relatively few inputs or outputs (pins). It is further realized herein that manually generating a data file for a testflow involving many dozens or hundreds of pins, which is the case for many testflows, is tedious and prone to error.

It is realized herein that an automated tool and method that would generate a data file, perhaps taking the form of an XML file, for ORE would be advantageous. It is further realized that a conventional scripting language may be employed to effect such a tool. It is further realized herein that such tool or method could also automatically import test data from datalog files and thereby provide useful input parameters to the test program.

Accordingly, described herein are various embodiments of an IC test tool and a system and method for automatically generating an ORE XML file.

FIG. 1 is a block diagram of one embodiment of an IC test tool. The test tool employs a test controller 110 configured to control a test fixture 120. A DUT 130 is coupled to the test fixture 120, allowing the test controller 110 to execute a test program 140 to test the DUT 130. The test program 140, which is almost always particularly designed specifically to test the specific DUT 130 being tested, causes electrical power and signals, which may be analog or digital signals, to be applied to the DUT 130 through the test fixture 120. Signals are produced by the DUT 130 in response thereto. The signals may be analog or digital signals. At least some of the signals are captured through the test fixture 120 and stored as test results 150. In terms of hardware, the test controller 110 may be embodied in a general-purpose or special-purpose processor, and the test program 130 and test results 150 may be stored in one or more memory devices, such as dynamic random-access memory (DRAM) or disk storage. The test fixture 120 may take the form of a conventional “bed-of-nails” or other conventional or later-developed test fixture configured to hold and test the DUT 130. The DUT 130 may be an IC, a circuit board containing multiple ICs or discrete parts or any other physical electrical or electronic circuit of any conventional or later-developed type or configuration.

As stated above, the test program 140 is almost always particularly designed specifically to test the specific DUT 130 being tested. Unfortunately, a DUT 130 suitable for verifying the proper operation of the test program 140 may not be available when the time for verification comes. Until ORE was developed, conventional circumstances dictated that verification of the test program 140 had to wait until a DUT 130 had been fabricated. Now that ORE has been developed, the operation of the test program 140 can be verified before a DUT 130 is available. However, as stated above, the structured data file required by ORE must be generated by hand, which is realized herein to be a tedious, time-consuming and error-fraught process. Accordingly, various embodiments of a system and method for automatically generating a structured data file, such as an XML file, for ORE will now be described.

“ORE,” as the term is used herein, is defined as hardware, firmware, software or hybrid process of employing information regarding the design of a DUT to emulate the DUT such that the operation of a test program designed to test the DUT can be verified without requiring an actual, fabricated DUT to be available. The above-referenced ORE implementation available from Advantest Corporation meets the definition of ORE, but so would ORE implementations by other companies.

FIG. 2 is a block diagram of one embodiment of a system for automatically generating an ORE XML file. In the embodiment of FIG. 2, the test program 140 of FIG. 1 is generated in a conventional manner using the test flow 210. In one embodiment, the test program 140 needs to be verified before any ICs for which it has been designed have been fabricated. In an alternative embodiment, the test program 140 can be used to verify the operation of an IC that is not available for online testing, which may be because the IC is far away from the test tool that would execute the test program 140.

In FIG. 2, the system is embodied in a structured data file generator 230 that includes a testflow integrator 231 and a DUT description integrator 232. In the illustrated embodiment, the testflow integrator 231 is configured to populate a supported testsuite 233 with parameters from the testflow 210 corresponding to the test program 140. In the illustrated embodiment, the DUT description integrator 232 is associated with the testflow integrator 231 and is configured further to populate the supported testsuite 233 with parameters from at least one DUT description file. Accordingly, FIG. 2 illustrates DUT description files 220, including a pin configuration file 221, a pattern master file 222 and a header file 223.

After the supported testsuite 233 is selected and thus populated, a structured data file 240 results. In the illustrated embodiment, the structured data file 240 takes the form of an XML file. Also in the illustrated embodiment, the structured data file 240 is further populated with simulation values 250.

Whether or not further populated with simulation values 250, the structured data file is employed in a conventional or later-developed ORE process 260 through which a test program or at least one of the DUT description files is verified.

FIG. 3 is a portion of an example ORE setup file rendered in XML and is presented primarily for the purpose of illustrating one example of a structured data file. Though the file of FIG. 3 is extremely simple, it is apparent that even it involves several measurements. A first measurement, “myMeasurement1,” involves a testsuite, “myTestSuite1,” applied to pin Q2 at a particular site 2 at which a value of 1.25 is applied. A second measurement, “myMeasurement3,” involves a pin Q4 at which a waveform including three values, 1.23, 1.24 and 1.25, are applied. A third measurement, “myMeasurement2,” involves a pin Q4 at which a waveform contained in the file “tx106ml.txt.”

FIG. 4 is a portion of an example supported testsuite employable to create an ORE setup file. The supported testsuite example of FIG. 4 is a continuity test involving primary conditions, called “Primaries,” and a test method involving the various parameters illustrated.

FIG. 5 is a portion of an example of an XML ORE setup file 510 created from the supported testsuite of FIG. 3. The supported testsuite of FIG. 4 is very simple. Even so, transforming the supported testsuite into the XML ORE file 510 of FIG. 5 is nontrivial. For example, it must be determined that PinGroups 1 through 5 are associated with Site 1 in the IC to which the XML ORE file corresponds. Only then can each of the PinGroups be assigned values, as FIG. 5 shows. A real-world testsuite is typically far more complex, involving perhaps dozens, if not hundreds, of pingroups. Further complicating matters is that ORE setup files may be required for many, e.g., separate testsuites.

FIG. 6 is a screenshot produced by one embodiment of a system for automatically generating an ORE XML file. The screenshot includes an area 610 in which a file containing a testflow can be selected, an area 620 in which an output name for the structured data file can be entered, an area 630 in which various supported testsuites are listed, an area 640 in which the number of sites can be designated and an area 650 that provides an output console for displaying messages from the system.

FIG. 7 is a diagram illustrating the generation of the ORE setup file 510 of FIG. 5 from a supported testsuite and a simulation values file. As described above, a list of supported testsuites 710 is displayed, allowing one to be selected. In the illustrated embodiment, the selected supported testsuite is a continuity testsuite 720. Simulation values 730, are likewise made available in a list and correspond to sites and pingroups in the DUT. As can be seen, a value 740 of −0.41 is assigned to pingroup 3 of site 1. It can be seen in FIG. 7 that the value 740 has been populated as a value 750 in the ORE setup file 510. Though they are unreferenced, it is apparent that other site 1 values from the list of simulation values are similarly populated into the ORE setup file 510. The process continues until the supported testsuite is transformed into an ORE setup file for the testsuite and typically further continued through other supported testsuites until the testflow is captured in an ORE setup file.

FIG. 8 is a diagram of one embodiment of a screenshot illustrating the import of testsuite values. FIG. 8 is presented primarily for the purpose of demonstrating that one embodiment of the system is capable of importing testsuite values for subsequent population of a supported testsuite.

FIG. 9 is a flow diagram of one embodiment of a method of automatically generating an ORE XML file. The method begins in a start step 910. In a step 920, a testflow corresponding to a test program is allowed to be selected. In a step 930, a plurality of selectable supported testsuites is provided. In a step 940, the selected supported testsuite is populated with parameters from the selected testflow. In a step 950, the selected supported testsuite is further populated with parameters from at least one DUT description file. In a step 960, the selected supported testsuite is further populated with simulation values. In a step 970, the resulting structured data file is employed for offline result emulation. The method ends in an end step 970.

Those skilled in the art to which this application relates will appreciate that other and further additions, deletions, substitutions and modifications may be made to the described embodiments.

What is claimed is:

1. A system for automatically generating a structured data file for offline result emulation, comprising:
a testflow integrator configured to populate a supported testsuite with parameters from a testflow corresponding to a test program; and
a device under test description integrator associated with said testflow integrator and configured further to populate said supported testsuite with parameters from at least one device under test description file.

2. The system as recited in claim 1 wherein said at least one device under test description file is selected from the group consisting of:
a pin configuration file,
a pattern master file, and
a header file.

3. The system as recited in claim 1 wherein said structured data file is further populated with testsuite values.

4. The system as recited in claim 1 wherein said testflow is further employed to develop a test program and said offline result emulation is operable to verify operation of said test program.

5. The system as recited in claim 1 wherein said offline result emulation is employed to verify said at least one device under test description file.

6. The system as recited in claim 1 wherein said device under test description integrator is further configured further to populate said supported testsuite with parameters from a complete device directory containing said at least one device under test description file.

7. The system as recited in claim 1 wherein said structured data file is an eXtensible Markup Language file.

8. A method of automatically generating a structured data file for offline result emulation, comprising:
allowing a testflow corresponding to a test program to be selected;
providing a plurality of selectable supported testsuites;
populating a selected one of said supported testsuites with parameters from said testflow;
further populating said selected one of said supported testsuites with parameters from at least one device under test description file thereby to yield a structured data file; and
employing said structured data file in said offline result emulation.

9. The method as recited in claim 8 wherein said at least one device under test description file is selected from the group consisting of:
a pin configuration file,
a pattern master file, and
a header file.

10. The method as recited in claim 8 further comprising further populating said structured data file with testate values.

11. The method as recited in claim 8 wherein said testflow is further employed to develop a test program, said method further comprising verifying an operation of said test program with said offline result emulation.

12. The method as recited in claim 8 further comprising said at least one device under test description file with said offline result emulation.

13. The method as recited in claim 8 wherein said further populating comprises further populating said supported testsuite with parameters from a complete device directory containing said at least one device under test description file.

14. The method as recited in claim 1 wherein said structured data file is an eXtensible Markup Language file.

15. A offline result emulator, comprising:
a testflow integrator configured to populate a supported testsuite with parameters from a testflow corresponding to a test program; and
a device under test description integrator associated with said testflow integrator and configured further to populate said supported testsuite with parameters from a complete device directory describing a device under test corresponding to said testflow and said test program.

16. The system as recited in claim 15 wherein said at least one device under test description file is selected from the group consisting of:
a pin configuration file,
a pattern master file, and
a header file.

17. The system as recited in claim 15 wherein said structured data file is further populated with testate values.

18. The system as recited in claim 15 wherein said testflow is further employed to develop a test program and said offline result emulation is operable to verify operation of said test program.

19. The system as recited in claim 15 wherein said offline result emulation is employed to verify said at least one device under test description file.

20. The system as recited in claim 15 wherein said structured data file is an eXtensible Markup Language file.
